(19) United States
(12) Patent Application Publication
(10) Pub. No.: US 2026/0156571 A1
(43) Pub. Date: Jun. 4, 2026

(54) APPARATUS AND METHOD FOR NETWORK ENERGY SAVING THROUGH AI-BASED DYNAMIC CELL ON/OFF IN WIRELESS COMMUNICATION SYSTEM

(71) Applicant: ELECTRONICS AND TELECOMMUNICATIONS RESEARCH INSTITUTE, Daejeon (KR)

(72) Inventor: Min Hyun KIM, Daejeon (KR)

(73) Assignee: ELECTRONICS AND TELECOMMUNICATIONS RESEARCH INSTITUTE, Daejeon (KR)

(21) Appl. No.: 19/403,598

(22) Filed: Nov. 28, 2025

(30) Foreign Application Priority Data
Nov. 29, 2024 (KR) 10-2024-0174734
Nov. 17, 2025 (KR) 10-2025-0173799

(51) Int. Cl. H04W 52/02

(52) U.S. Cl. CPC H04W 52/0219

(57) ABSTRACT

The present disclosure relates generally to wireless communication systems, and more particularly to an apparatus and method for network energy saving through artificial intelligence-based dynamic cell on/off in wireless communication systems. A method of operating a Non-Real-Time RAN Intelligent Controller according to the present disclosure includes collecting time-sequential channel state information from a plurality of cells, generating on/off decision information for each of the plurality of cells based on the time-sequential channel state information using an artificial intelligence model, and controlling on/off states of the plurality of cells by transmitting the on/off decision information to an E2 node. The artificial intelligence model is configured based on models that learn time-sequential patterns (e.g., LSTM, GRU, Transformer, reinforcement learning-based policy networks), learns time-sequential patterns, and is optimized to maximize network energy saving performance.

### CROSS REFERENCE TO RELATED APPLICATION

This application claims priority to Korean Patent Application No. 10-2024-0174734, filed on Nov. 29, 2024, and Korean Patent Application No. 10-2025-0173799, filed on Nov. 17, 2025, the entire contents of which are hereby incorporated by reference.

### BACKGROUND OF THE INVENTION

### Field of the Invention

The present disclosure relates generally to wireless communication systems, and more particularly to an apparatus and method for network energy saving through artificial intelligence (AI)-based dynamic cell on/off in wireless communication systems.

### Description of the Related Art

As mobile services have evolved, including social networking, video streaming, and online gaming, evolved mobile communication networks beyond Long Term Evolution (LTE) have been required to satisfy technical requirements not only for high transmission rates but also for supporting more diverse service scenarios. The International Telecommunication Union Radiocommunication Sector (ITU-R) has defined key performance indicators and requirements for IMT-2020 (International Mobile Telecommunications-2020), which is the official designation for the fifth generation (5G) of mobile communications. These requirements are summarized as high transmission rates (enhanced Mobile Broadband, eMBB), short transmission delay (Ultra-Reliable and Low Latency Communications, URLLC), and massive terminal connectivity (massive Machine Type Communications, mMTC).

The 3rd Generation Partnership Project (3GPP), which is an international standardization organization for mobile communications, has been developing fifth-generation standard specifications based on new radio access technology that satisfies the IMT-2020 requirements. In the fifth generation, significant changes are occurring in network control, operation, and management, such as introducing the concepts of Software-Defined Networking (SDN) and Network Function Virtualization (NFV) in the core network for automation and intelligence. However, the radio access network including base stations still maintains a closed structure that is dependent on specific equipment manufacturers' protocols and interfaces, causing interoperability issues between different equipment manufacturers and preventing market entry for various manufacturers.

Accordingly, in February 2018, five global telecommunications operators including AT&T, China Mobile, Deutsche Telekom, NTT Docomo, and Orange took the initiative to establish the O-RAN Alliance, with the goal of transforming the radio access network industry into a more intelligent, open, virtualized, and fully interoperable mobile communication network. Currently, the alliance consists of approximately 300 member companies including telecommunications operators, enterprises, and research institutions, and is engaged in standardization and open source platform development to promote the development of open and intelligent radio access networks for the fifth generation and further for the sixth generation.

O-RAN realized by the O-RAN Alliance basically means an open radio access network and encompasses all technologies that enable interoperation and use of base station equipment made by different manufacturers. The O-RAN architecture defines the ability to configure a virtualized radio access network on open hardware and has introduced a component called the RAN Intelligent Controller (RIC) for AI/machine learning (ML)-based radio access network control. The RAN Intelligent Controller is operated separately as a Non-Real-Time RIC and a Near-Real-Time RIC based on control time and main functions.

Meanwhile, with the recent surge in data traffic in the mobile communications industry, increased operating costs, and the highlighted need for carbon emission reduction, network energy saving has emerged as an important challenge. In particular, as high-density networks and small cell usage spread to satisfy the explosively increasing mobile traffic requirements in the fifth-generation environment, a situation has arisen where network equipment consumes significant energy even in low traffic or no traffic states, and overall energy consumption is also on an increasing trend.

Conventional network energy saving methods have primarily used a method of selectively turning off underutilized base stations among energy-consuming base stations. When multiple frequency carriers are used to cover the same service area, energy savings can be achieved by deactivating one or more carriers or an entire cell without affecting user experience when the traffic load of a certain carrier or cell is low. At this time, before deactivating a carrier or cell, user terminals that were being served by that carrier or cell are transferred to other activated carriers or cells.

However, the on/off decision for base stations, carriers, or cells is a very complex problem. Since the mobile traffic environment changes over time, it is difficult to determine the on/off status of all base stations for each situation considering the conflicting goals of network performance and energy saving. In addition, when a carrier or cell is deactivated, other carriers or cells must handle additional traffic, requiring sophisticated technical support to coordinate traffic and energy consumption, and although energy savings of the deactivated carrier or cell may be achieved, there is also a possibility that the overall network energy consumption may actually increase.

### SUMMARY OF THE INVENTION

Based on the discussions as described above, the present disclosure provides an apparatus and method for saving network energy by dynamically determining the on/off state of cells based on channel state information in a wireless communication system.

In addition, the present disclosure provides an apparatus and method for inferring optimal cell on/off patterns from time-sequential channel state information by utilizing artificial intelligence models (e.g., LSTM, GRU, Transformer, reinforcement learning-based policy networks) that learn time-sequential patterns in a wireless communication system.

Furthermore, the present disclosure provides an apparatus and method for implementing intelligent energy saving policies through a Non-Real-Time RAN Intelligent Controller and applications in a wireless communication system.

According to various embodiments of the present disclosure, a method of operating a Non-Real-Time RAN Intelligent Controller for network energy saving in a wireless communication system includes collecting time-sequential channel state information from a plurality of cells, generating on/off decision information for each of the plurality of cells based on the time-sequential channel state information using an artificial intelligence model, and controlling the on/off states of the plurality of cells by transmitting the on/off decision information to an E2 node.

According to various embodiments of the present disclosure, a method of operating an E2 node for network energy saving in a wireless communication system includes receiving on/off decision information for a plurality of cells from a Non-Real-Time RAN Intelligent Controller, handing over user terminals being served by cells determined to be off among the plurality of cells to cells determined to be on according to the on/off decision information, and deactivating the cells determined to be off after completion of the handover.

According to various embodiments of the present disclosure, a Non-Real-Time RAN Intelligent Controller for network energy saving in a wireless communication system includes a transceiver and a processor operatively connected to the transceiver, wherein the processor is configured to collect time-sequential channel state information from a plurality of cells, generate on/off decision information for each of the plurality of cells based on the time-sequential channel state information using an artificial intelligence model, and control the on/off states of the plurality of cells by transmitting the on/off decision information to an E2 node.

According to various embodiments of the present disclosure, an E2 node for network energy saving in a wireless communication system includes a transceiver and a processor operatively connected to the transceiver, wherein the processor is configured to receive on/off decision information for a plurality of cells from a Non-Real-Time RAN Intelligent Controller, hand over user terminals being served by cells determined to be off among the plurality of cells to cells determined to be on according to the on/off decision information, and deactivate the cells determined to be off after completion of the handover.

The apparatus and method according to various embodiments of the present disclosure enable effective reduction of energy consumption while maintaining network performance by analyzing time-sequential channel state information with an artificial intelligence model to dynamically determine cell on/off patterns. By using time-sequential channel state information analysis through the artificial intelligence model to dynamically determine cell on/off patterns, the apparatus and method effectively reduce energy consumption while maintaining network performance.

In addition, the apparatus and method according to various embodiments of the present disclosure enable securing stable energy saving performance even in environments with severe traffic fluctuations by adaptively responding to real-time network conditions through the integration of the Non-Real-Time RAN Intelligent Controller framework and network energy saving applications.

Effects obtainable from the present disclosure are not limited to the effects mentioned above, and other effects not mentioned can be clearly understood by those having ordinary knowledge in the technical field to which the present disclosure pertains from the description below.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 illustrates an overall structure of an O-RAN system according to an embodiment of the present disclosure.

FIG. 2 illustrates a detailed structure of a Non-RT RIC according to an embodiment of the present disclosure.

FIG. 3 illustrates a detailed structure of a Near-RT RIC according to an embodiment of the present disclosure.

FIG. 4 illustrates an embodiment of AI/ML-based dynamic cell on/off technology according to an embodiment of the present disclosure.

FIG. 5 illustrates an AI/ML-based dynamic cell on/off procedure according to an embodiment of the present disclosure.

FIG. 6 illustrates a detailed structure of an AI/ML model for cell on/off according to an embodiment of the present disclosure.

FIG. 7 illustrates a training data generation method for an AI/ML model for cell on/off according to an embodiment of the present disclosure.

FIG. 8 illustrates a flowchart of an operating method of a Non-Real-Time RAN Intelligent Controller for network energy saving according to an embodiment of the present disclosure.

FIG. 9 illustrates a flowchart of an operating method of a base station device for network energy saving according to an embodiment of the present disclosure.

### DETAILED DESCRIPTION OF THE INVENTION

Terms used in the present disclosure are merely used to describe specific embodiments and may not be intended to limit the scope of other embodiments. Singular expressions may include plural expressions unless the context clearly indicates otherwise. Technical or scientific terms used herein may have the same meanings as commonly understood by one of ordinary skill in the technical field described in the present disclosure. Among terms used in the present disclosure, terms defined in general dictionaries may be interpreted as having meanings identical or similar to those in the context of related art, and are not interpreted as ideal or excessively formal meanings unless explicitly defined in the present disclosure. In some cases, even terms defined in the present disclosure cannot be interpreted to exclude embodiments of the present disclosure.

In various embodiments of the present disclosure described below illustrate hardware-based approaches as examples. However, since various embodiments of the present disclosure include technologies using both hardware and software, various embodiments of the present disclosure do not exclude software-based approaches.

In addition, in the detailed description and claims of the present disclosure, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

Hereinafter, the present disclosure relates to an apparatus and method for network energy saving through AI-based dynamic cell on/off in a wireless communication Specifically, the present disclosure describes a technology for dynamically controlling cell on/off through an artificial intelligence model utilizing time-sequential channel state information to save network energy in a wireless communication system. The following embodiments are mainly described based on the O-RAN (Open Radio Access Network) architecture, but the technical concept of the present disclosure is not limited to O-RAN and can be equally applied to 3GPP standard-based networks, proprietary wireless network architectures, or any form of wireless communication system where network control functions and radio access functions are separated.

Terms referring to signals, terms referring to channels, terms referring to control information, terms referring to network entities, and terms referring to components of devices used in the following description are exemplified for convenience of description. Therefore, the present disclosure is not limited to the terms described below, and other terms with equivalent technical meanings may be used.

In addition, although the present disclosure describes various embodiments using terms used in some communication standards (e.g., 3GPP (3rd Generation Partnership Project)), this is merely an example for explanation. Various embodiments of the present disclosure can be easily modified and applied to other communication systems as well.

In the present disclosure, “network control device” refers to a device that determines network optimization and energy saving policies. The network control device may be implemented as a Non-Real-Time RAN Intelligent Controller (Non-RT RIC) in the O-RAN architecture. “Radio access node” or “base station device” refers to a node that manages radio resources and communicates directly with user terminals. In the O-RAN architecture, the base station device corresponds to an E2 node, such as an O-CU-CP, O-CU-UP, O-DU, or O-eNB. The E2 node becomes a target for data collection and transmission/reception of control commands through the E2 Termination of the Near-RT RIC.

“βt” means channel state information (CSI) at time t, and “L” is an integer representing the length of a time window. “M” means the total number of cells subject to on/off control, and “αt+1” means an M-dimensional binary vector indicating the on/off state of each cell at the next time (t+1). “τ” is a threshold applied to sigmoid output to perform binary decision and is used as a parameter to balance network performance and energy saving. In the present disclosure, these terms are used with the same notation and meaning even after the initial definition.

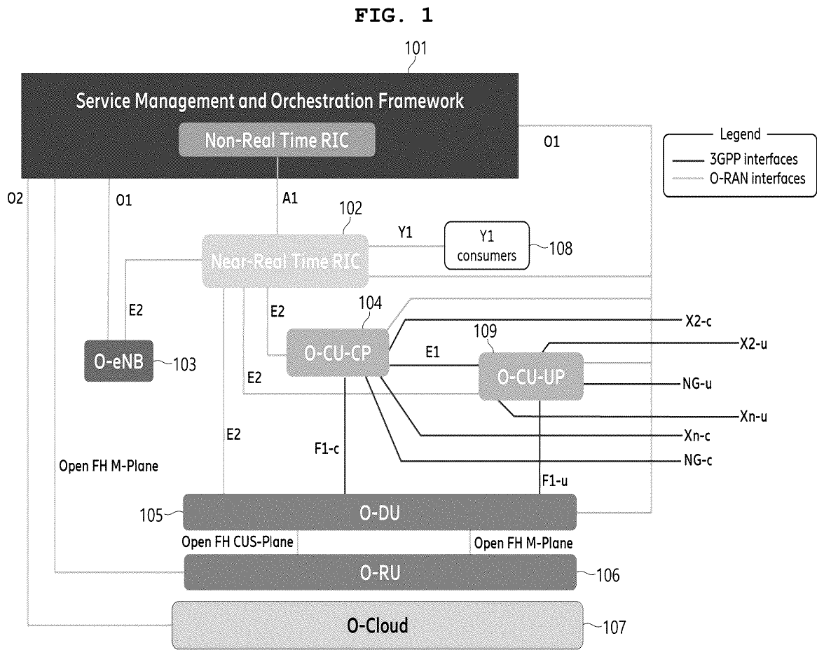

FIG. 1 illustrates an overall structure of an O-RAN system according to an embodiment of the present disclosure.

Referring to FIG. 1, the O-RAN system includes a Service Management and Orchestration Framework (101), a Near-RT RIC (102), an O-eNB (103), an O-CU-CP (104), an O-DU (105), an O-RU (106), an O-Cloud (107), Y1 consumers (108), and an O-CU-UP (109).

The Service Management and Orchestration Framework (101) is responsible for the management and operation of the entire O-RAN system and includes a Non-RT RIC internally. The Non-RT RIC performs network optimization with a processing time of 1 second or more and communicates with the Near-RT RIC (102) through the A1 interface. In addition, it manages each network element through the O1 interface.

The Near-RT RIC (102) has a control time between 10 milliseconds and 1 second and communicates with E2 nodes such as O-eNB (103), O-CU-CP (104), O-CU-UP (109), and O-DU (105) through the E2 interface. The Near-RT RIC (102) can provide analysis information to Y1 consumers (108) through the Y1 interface.

The O-CU-CP (104) is responsible for control plane functions and performs Radio Resource Control (RRC) and the control part of Packet Data Convergence Protocol (PDCP). The O-CU-UP (109) is responsible for user plane functions and performs the user part of PDCP and Service Data Adaptation Protocol (SDAP). The O-CU-CP (104) and O-CU-UP (109) communicate with each other through the E1 interface.

The O-DU (105) is responsible for Radio Link Control (RLC), Medium Access Control (MAC), and High-PHY layer functions and communicates with the O-CU-CP (104) and O-CU-UP (109) through the F1 interface. The O-RU (106) is responsible for Low-PHY layer functions and is connected to the O-DU (105) through the Open Fronthaul interface.

The O-Cloud (107) is a cloud computing platform on which O-RAN functions are deployed and is connected to the Service Management and Orchestration Framework (101) through the O2 interface. Each network element communicates with adjacent base stations through the X2 interface and is connected to the core network through the NG interface.

The network saving function of the present disclosure is mainly implemented through the interaction between the Non-RT RIC (corresponding to the network control device) within the Service Management and Orchestration Framework (101) and E2 nodes (103, 104, 105, 109) (corresponding to base station devices).

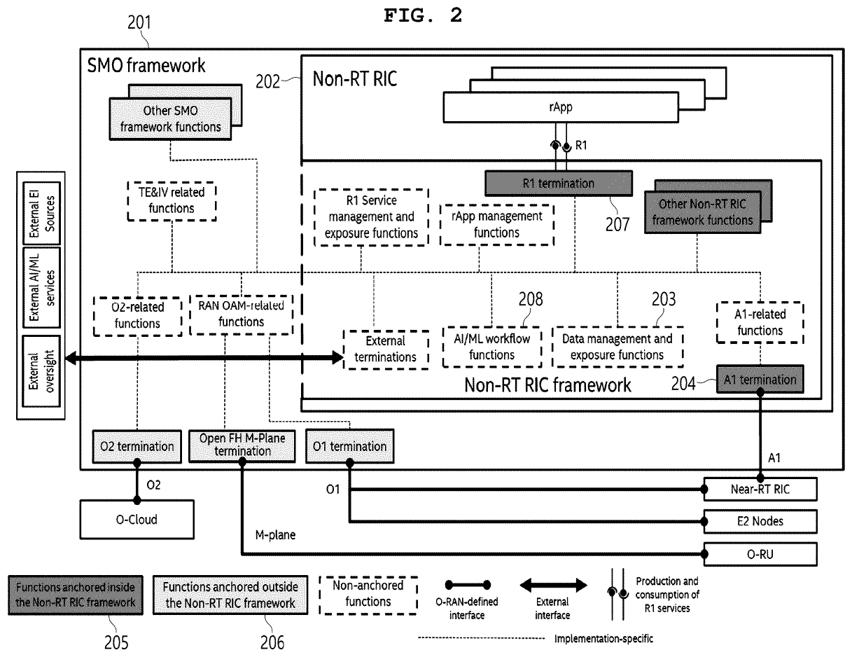

FIG. 2 illustrates a detailed structure of a Non-RT RIC according to an embodiment of the present disclosure.

Referring to FIG. 2, the Non-RT RIC includes an SMO framework 201, a Non-RT RIC 202, Data management and exposure functions 203, A1 termination 204, Functions anchored inside the Non-RT RIC framework 205, Functions anchored outside the Non-RT RIC framework 206, and R1 termination 207.

The SMO framework 201 includes Other SMO Framework Functions and is responsible for overall service management and orchestration functions. The SMO framework 201 communicates with the O-Cloud through the O2 interface and is connected to network elements such as the Near-RT RIC, E2 Nodes, and O-RUs through the O1 interface.

The Non-RT RIC 202 is a core component implementing the network energy saving function of the present disclosure and includes rApp, R1 enrichment and exposure functions, Data platform related functions, AI/ML workflow functions, Other Non-RT RIC Framework Functions, and the like.

The Data management and exposure functions 203 perform a core function of storing and managing channel state information collected from E2 nodes. In the present disclosure, this functional block is responsible for storing time-sequential channel state information (CSI) during a preset time window and memory management that deletes old data exceeding the time window.

The A1 termination 204 provides a termination function that communicates with the Near-RT RIC through the A1 interface. In the present disclosure, the A1 termination 204 performs a role of delivering cell on/off decision policies generated by the rApp to the Near-RT RIC.

The R1 termination 207 is responsible for communication between the rApp and the Non-RT RIC framework through the R1 interface. The rApp acquires time-sequential channel state information from the Data management and exposure functions 203 through the R1 termination 207 and delivers processing results to the Non-RT RIC framework.

The rApp within the Non-RT RIC 202 is a Network Energy Saving rApp that receives time-sequential channel state information as input from the Data management and exposure functions 203 through the R1 interface. The rApp generates on/off decision information for each of a plurality of cells by utilizing an embedded artificial intelligence model (e.g., LSTM, GRU, Transformer, reinforcement learning-based policy network) and delivers this to the Near-RT RIC through the A1 termination 204.

The AI/ML workflow functions manage the training, validation, and deployment of artificial intelligence models and optimize the models to maximize network energy saving performance. The Data platform related functions provide platform functions for large-scale data processing and storage.

The Functions anchored inside the Non-RT RIC framework 205 and the Functions anchored outside the Non-RT RIC framework 206 indicate that the functions of the Non-RT RIC can be flexibly deployed inside or outside the framework. This structural flexibility enables optimization and expansion of functions according to system requirements.

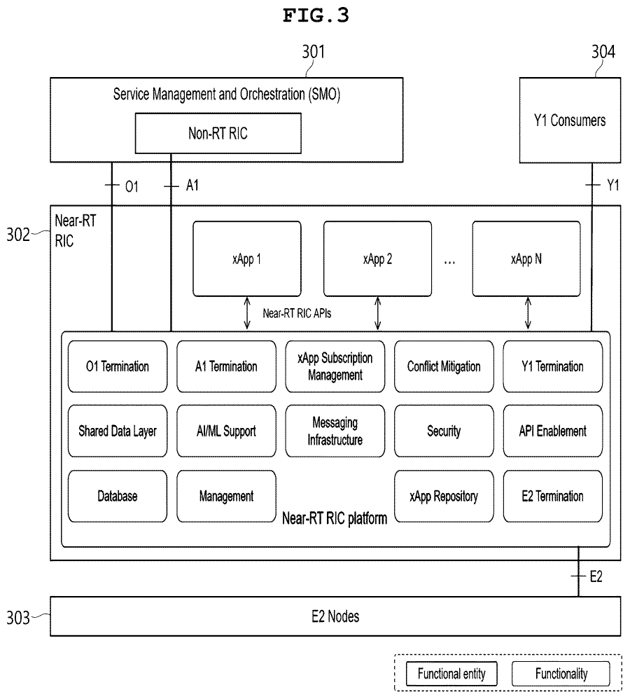

FIG. 3 illustrates a detailed structure of a Near-RT RIC according to an embodiment of the present disclosure.

Referring to FIG. 3, the Near-RT RIC includes Service Management and Orchestration 301, Near-RT RIC 302, E2 Nodes 303, and Y1 Consumers 304.

The Service Management and Orchestration 301 includes the Non-RT RIC, manages the Near-RT RIC 302 through the O1 interface, and provides policy and enrichment information to the Near-RT RIC 302 through the A1 interface.

The Near-RT RIC 302 is a core component for near-real-time control and hosts a plurality of xApps from xApp 1, xApp 2 to xApp N. Each xApp communicates with the Near-RT RIC platform through Near-RT RIC APIs. The Near-RT RIC 302 includes functional blocks such as O1 Termination, A1 Termination, xApp Subscription Management, Conflict Mitigation, Y1 Termination, Shared Data Layer, AI/ML Support, Messaging Infrastructure, Security, API Enablement, Database, Management, Near-RT RIC platform, xApp Repository, and E2 Termination.

The O1 Termination is responsible for the management interface with the Service Management and Orchestration 201, and the A1 Termination receives policies from the Non-RT RIC. In the present disclosure, the A1 Termination performs a role of receiving cell on/off decision policies from the Network Energy Saving rApp of the Non-RT RIC.

The xApp Subscription Management manages E2 node data subscriptions of xApps, and the Conflict Mitigation coordinates conflicts between multiple xApps. The Shared Data Layer stores and manages data shared by the xApps.

The AI/ML Support provides artificial intelligence and machine learning functions that can be utilized by the xApps. In the present disclosure, additional optimization can be performed to apply cell on/off policies received from the Non-RT RIC in near-real-time.

The E2 Termination communicates with E2 Nodes 303 through the E2 interface. The E2 Nodes 303 include O-CU-CP, O-CU-UP, O-DU, O-eNB, and the like, and are responsible for actual radio resource management and data transmission. In the present disclosure, the E2 Termination delivers cell on/off control commands to the E2 Nodes 303 and collects measurement data such as channel state information.

The Y1 Termination provides analysis information to Y1 Consumers 304 through the Y1 interface. The Y1 Consumers 304 are external entities that utilize network analysis information generated by the Near-RT RIC 302.

The Messaging Infrastructure is responsible for message exchange within the Near-RT RIC 302, and Security provides security functions. The Database stores data necessary for operation of the Near-RT RIC 302, and Management performs overall management functions of the Near-RT RIC 302.

The Functional entity and Functionality below E2 Nodes 303 represent various functions provided by E2 nodes. In the present disclosure, the E2 Nodes 303 perform actual activation/deactivation of cells according to cell on/off control commands received from the Near-RT RIC 302 and execute necessary procedures such as handover.

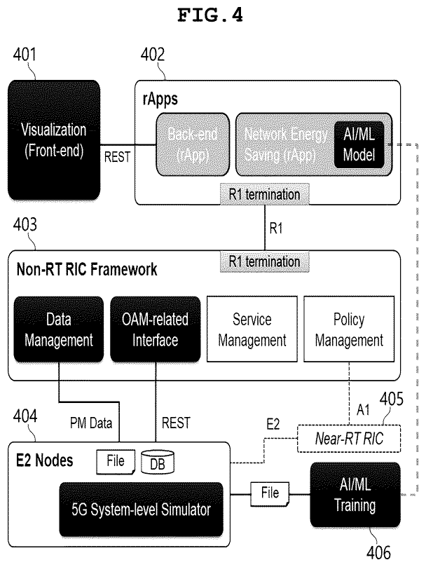

FIG. 4 illustrates an embodiment of AI/ML-based dynamic cell on/off technology according to an embodiment of the present disclosure.

Referring to FIG. 4, the system includes Visualization 401, rApps 402, Non-RT RIC Framework 403, E2 Nodes 404, Near-RT RIC 405, and AI/ML Training 406.

The Visualization 401 provides a front-end visualization function and communicates with the rApps 402 and the Non-RT RIC Framework 403 through a REST interface. System operators can monitor network status and energy saving performance through the Visualization 401.

The rApps 402 include Back-end (rApp), Network Energy Saving (rApp), and AI/ML Model. The Network Energy Saving rApp is a core component of the present disclosure and performs cell on/off decisions by receiving time-sequential channel state information as input. The AI/ML Model is configured with artificial intelligence models that learn time-sequential patterns (e.g., LSTM, GRU, Transformer, reinforcement learning-based policy networks) and is embedded and executed within the Network Energy Saving rApp.

The Non-RT RIC Framework 403 includes Data Management, OAM-related Interface, Service Management, and Policy Management. The Data Management stores and manages PM (Performance Management) Data collected from the E2 Nodes 404. In the present disclosure, the Data Management stores time-sequential channel state information and manages data according to a preset time window. The OAM-related Interface communicates with the E2 Nodes 404 through a REST interface and delivers cell on/off control commands.

The E2 Nodes 404 include a 5G System-level Simulator to simulate an actual network environment. The 5G System-level Simulator generates a realistic network environment by simulating cell placement, user terminal distribution, traffic patterns, channel conditions, and the like. The E2 Nodes 404 store data in the form of Files and DB and provide PM Data to the Non-RT RIC Framework 403. In addition, they communicate with the Near-RT RIC 405 through the E2 interface.

The Near-RT RIC 405 receives cell on/off policies from the Non-RT RIC Framework 403 through the A1 interface and delivers near-real-time control commands to the E2 Nodes 404 through the E2 interface. In the present disclosure, the Near-RT RIC 405 performs a role of coordinating actual cell on/off operations based on decisions from the Non-RT RIC.

The AI/ML Training 406 receives training data from the E2 Nodes 404 through a File interface. The AI/ML Training 406 trains the artificial intelligence model using the collected data and optimizes model parameters to maximize network energy saving performance.

In this structure, the Network Energy Saving rApp operates in a flow of receiving time-sequential channel state information from the Data Management of the Non-RT RIC Framework 403, generating on/off decisions for each cell through the embedded AI/ML Model, and then delivering control commands to the E2 Nodes 404 through the OAM-related Interface.

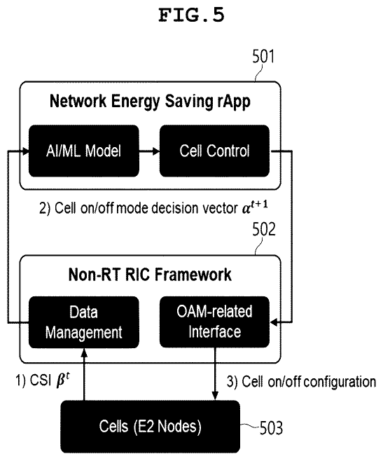

FIG. 5 illustrates an AI/ML-based dynamic cell on/off procedure according to an embodiment of the present disclosure.

Referring to FIG. 5, the system includes a Network Energy Saving rApp 501, a Non-RT RIC Framework 502, and Cells (E2 Nodes) 503, and operates in a three-step procedure.

The Network Energy Saving rApp 501 includes an AI/ML Model and a Cell Control functional block. The AI/ML Model is an artificial intelligence model that learns time-sequential patterns according to the present disclosure (e.g., LSTM, GRU, Transformer, reinforcement learning-based policy network), and the Cell Control generates cell control commands based on the model's output.

The Non-RT RIC Framework 502 includes Data Management and an OAM-related Interface. The Data Management manages channel state information, and the OAM-related Interface is responsible for communication with E2 nodes.

The Cells (E2 Nodes) 503 represent actual cells or simulated cells, provide channel state information, and receive on/off control commands.

The operation procedure is as follows:

Step 1: CSI β^{t} Collection Channel state information (CSI) β\hat{ }t\hat{ } measured at time t in Cells (E2 Nodes) 503 is transmitted to the Data Management of the Non-RT RIC Framework 502. The Data Management stores the received CSI in time-sequential order and manages data according to a preset time window. Old CSI exceeding the time window is deleted for memory efficiency. The Data Management stores CSI periodically collected from E2 nodes together with time indices and performs sequential storage and deletion according to the preset time window L. Accordingly, past CSI that has elapsed beyond L is removed for memory efficiency, and the latest sequence of length L is provided for model inference of the rApp.

Step 2: Cell on/off mode decision vector α^{t+1} Generation The Data Management of the Non-RT RIC Framework 502 delivers the stored time-sequential CSI information to the Network Energy Saving rApp 501. The AI/ML Model within the rApp 501 processes the input CSI sequence with the artificial intelligence model to generate a cell on/off decision vector α\hat{ }t+1\hat{ } for the next time slot (t+1).

Step 3: Cell on/off configuration The Cell Control of the Network Energy Saving rApp 501 delivers the generated cell on/off decision vector to the OAM-related Interface of the Non-RT RIC Framework 502. The OAM-related Interface transmits on/off configuration commands to each Cells (E2 Nodes) 503 based on this information. Cells determined to be off hand over user terminals to adjacent on-state cells and then are deactivated, while cells determined to be on maintain an active state or are reactivated.

This three-step procedure is repeatedly executed periodically to dynamically adjust cell on/off states according to network condition changes, thereby minimizing energy consumption while maintaining network performance.

As described above, the calculated on/off decision vector is delivered to the OAM-related interface of the Non-RT RIC Framework by the control function of the rApp, and this interface instructs on/off configuration to each E2 node. After confirmation that handover of user terminals to adjacent on-state cells is completed, cells determined to be off stop radio transmission/reception functions and switch baseband processing to low-power mode. In situations where traffic load exceeds a threshold, reactivation of deactivated cells is requested to maintain network performance. The series of procedures described above is repeatedly performed periodically in response to changes in network conditions.

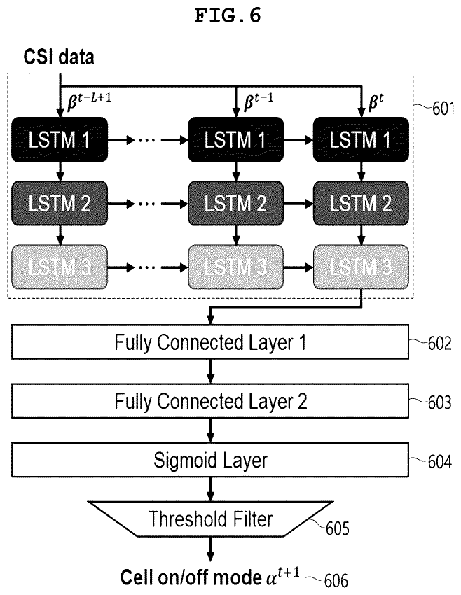

FIG. 6 illustrates a detailed structure of an AI/ML model for cell on/off according to an embodiment of the present disclosure.

The artificial intelligence model according to the present disclosure receives a time-sequential CSI sequence {β^{t-L+1}, . . . , β^{t}} as input and learns temporal patterns in a time-sequential learning layer (e.g., LSTM layer, GRU layer, Transformer encoder, or recurrent policy network). The output of the time-sequential learning layer is transformed into an M-dimensional vector through two consecutive fully connected layers, and this vector is normalized to values between 0 and 1 in a sigmoid layer to represent the probability of each cell being in an on state. Subsequently, a threshold filter compares the sigmoid output with a threshold τ and converts it into binary values, thereby producing a cell on/off decision vector α^{t+1} for the next time slot (t+1). In the process described above, M is the total number of cells subject to control, τ is a parameter set for balancing performance and energy saving, and the produced α\hat{ }t+1\hat{ } includes indications of on (1) or off (0) for each cell.

Referring to FIG. 6, the AI/ML model includes a time-sequential learning layer 601, Fully Connected Layer 1 (602), Fully Connected Layer 2 (603), a Sigmoid Layer 604, and a Threshold Filter 605, and finally outputs Cell on/off mode α^{t+1} (606).

The time-sequential learning layer 601 may be configured with a plurality of recurrent layers (e.g., LSTM layers, GRU layers) or attention-based layers (e.g., Transformer encoder). The input CSI data is in the form of time-sequentially arranged {β^{t-L+1}, . . . , β^{t}}, where L represents the length of the time window. In one embodiment, CSI data of each time slot is simultaneously input to a plurality of parallel layers to learn patterns of various time scales. The time-sequential learning layer learns short-term, mid-term, and long-term patterns of time-sequential CSI data and models temporal correlations by transferring information from previous time slots to the next time slots.

Fully Connected Layer 1 (602) receives the last time slot output of the time-sequential learning layer 601. This layer combines the output features of the time-sequential learning layer to generate a high-dimensional representation.

Fully Connected Layer 2 (603) receives the output of Fully Connected Layer 1 (602) as input and transforms it into an M-dimensional vector. Here, M represents the total number of cells subject to control.

The Sigmoid Layer 604 applies a sigmoid activation function to the output of Fully Connected Layer 2 (603) to normalize each value between 0 and 1. This represents the probability of each cell being in an on state.

The Threshold Filter 605 applies a threshold τ to the output of the Sigmoid Layer 604. If the value corresponding to each cell is greater than the threshold τ, it is converted to 1 (on), and if it is less than or equal to the threshold τ, it is converted to 0 (off). The threshold τ is used as a parameter to adjust the balance between network performance and energy saving.

Cell on/off mode α^{t+1} (606) is the final output and is an M-dimensional binary vector representing the on/off state of each cell in the next time slot (t+1). If the i-th element of this vector is 1, it instructs to set the i-th cell to an on state, and if it is 0, to set it to an off state.

Through this model structure, complex patterns of time-sequential CSI information can be learned, and cell on/off decisions suitable for network conditions can be generated. In one embodiment, the time-sequential learning layer may be implemented with one or more of LSTM, GRU, Transformer, or reinforcement learning-based policy networks.

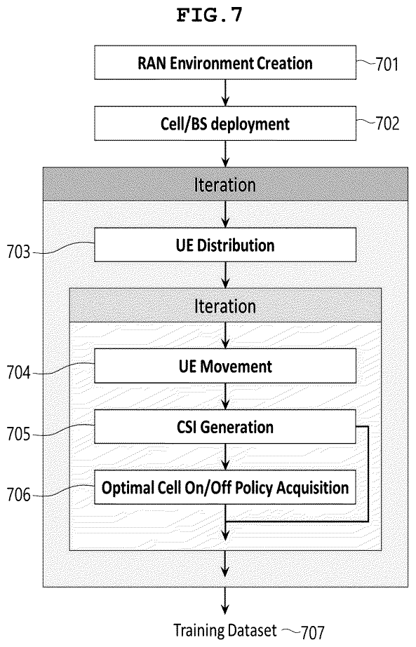

FIG. 7 illustrates a training data generation method for an AI/ML model for cell on/off according to an embodiment of the present disclosure.

Referring to FIG. 7, the training data generation procedure includes RAN Environment Creation 701, Cell/BS deployment 702, UE Distribution 703, UE Movement 704, CSI Generation 705, Optimal Cell On/Off Policy Acquisition 706, and Training Dataset 707.

RAN Environment Creation 701 generates a RAN simulation environment that simulates an actual mobile communication environment. In this step, basic parameters such as geographic area, frequency band, and propagation model are set.

Cell/BS deployment 702 deploys cells and base stations within the simulation environment. Cells are fixedly deployed at predefined locations, and coverage, transmission power, antenna configuration, and the like of each cell are set.

UE Distribution 703 distributes user terminals in the simulation environment. User terminals are deployed randomly or according to specific distribution patterns, which simulates traffic distribution of an actual network. An iteration section begins from this step.

UE Movement 704 simulates movement of each user terminal. User terminals move in random directions and speeds, which reflects actual user movement patterns. An inner iteration section begins from this step.

CSI Generation 705 generates channel state information between each base station and user terminal. CSI is calculated according to 3GPP standards considering path loss, shadowing, fading, and the like. The generated CSI is stored time-sequentially and is expressed in the form of β\hat{ }t\hat{ }.

Optimal Cell On/Off Policy Acquisition 706 determines an optimal cell on/off policy at each time slot. In this step, an optimal policy is calculated using a network energy saving performance metric. The network energy saving performance is defined by the following equation:

$${P}_{NES} = {\sum }_{all UE k} {R}_{k} - γ {\sum }_{all Cell m} {P}_{m} \qquad [ Equation 1 ]$$

Here, the first term Σ_{all UE k}Rₖ represents the total data rate of all user terminals, and the second term γΣ_{all Cell m}Pₘ represents the total power consumption of all cells. γ is a normalization factor that adjusts the balance between network performance and energy saving. The optimal policy α^{t+1} is obtained by computationally searching for a cell on/off combination that maximizes this metric.

Training Dataset 707 represents the final training dataset. The process from UE Movement 704 to Optimal Cell On/Off Policy Acquisition 706 is repeated to collect CSI and optimal cell on/off policy pairs for various scenarios. In addition, data for various user distribution patterns is generated through outer iteration from UE Distribution 703. The large-scale dataset collected in this manner is used for training the artificial intelligence model.

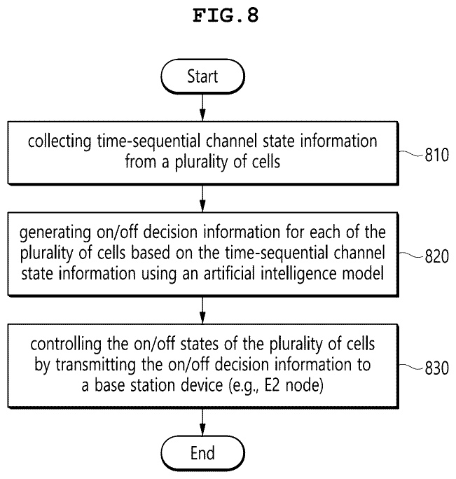

FIG. 8 illustrates a flowchart of an operating method of a network control device (e.g., Non-Real-Time RAN Intelligent Controller of O-RAN) for network energy saving according to an embodiment of the present disclosure.

Referring to FIG. 8, the operating method of the network control device includes step 810, step 820, and step 830 after starting and ends.

In step 810, the network control device collects time-sequential channel state information from a plurality of cells. In one embodiment, the network control device periodically receives CSI from base station devices (e.g., E2 nodes) through a management interface (e.g., O1 interface of O-RAN). The received CSI is expressed in the form of β\hat{ }t\hat{ } and is stored together with a time index t. In another embodiment, the network control device stores CSI during a preset time window L.

Old CSI exceeding the time window is automatically deleted for memory efficiency. In yet another embodiment, the CSI may include a Channel Quality Indicator (CQI), Reference Signal Received Power (RSRP), Signal to Interference plus Noise Ratio (SINR), and the like between each cell and user terminals.

In step 820, the network control device generates on/off decision information for each of the plurality of cells based on the time-sequential channel state information using an artificial intelligence model. In one embodiment, the artificial intelligence model includes a time-sequential learning layer (e.g., LSTM layer, GRU layer, Transformer encoder, or recurrent policy network), two fully connected layers, a sigmoid layer, and a threshold filter. In another embodiment, the artificial intelligence model receives and processes a time-sequential CSI sequence {β^{t-L+1}, . . . , β^{t-1}, β^{t}} as input. In yet another embodiment, the threshold filter applies a threshold τ to the sigmoid output to generate binary on/off decisions for each cell. In an additional embodiment, the on/off decision information α^{t+1} is configured as an M-dimensional binary vector, where M represents the number of cells subject to control.

In step 830, the network control device controls the on/off states of the plurality of cells by transmitting the on/off decision information to a base station device. In one embodiment, the network control device delivers an on/off policy to a near-real-time controller (e.g., Near-RT RIC) through a policy interface (e.g., A1 interface of O-RAN). In another embodiment, the network control device directly transmits on/off configuration commands to a base station device (e.g., E2 node) through a management interface (e.g., O1 interface). In yet another embodiment, the on/off control commands include detailed information such as on/off timing for each cell, transition time, handover parameters, and the like.

In an additional embodiment, the network control device may calculate network energy saving performance based on network performance metrics and energy consumption and continuously train the artificial intelligence model to maximize this performance. The network energy saving performance is calculated using Equation 1, and through this, the model's performance is evaluated and improved.

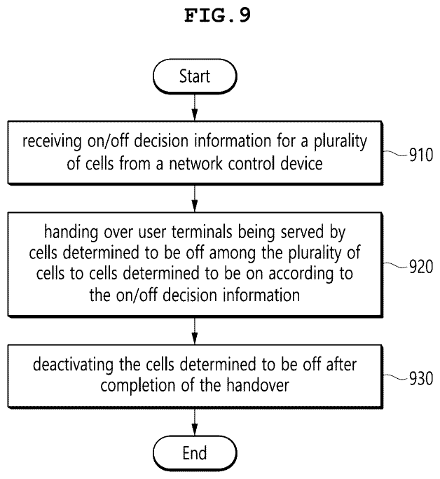

FIG. 9 illustrates a flowchart of an operating method of a base station device (e.g., E2 node of O-RAN) for network energy saving according to an embodiment of the present disclosure.

Referring to FIG. 9, the operating method of the base station device includes step 910, step 920, and step 930 after starting and ends.

In step 910, the base station device receives on/off decision information for a plurality of cells from a network control device. In one embodiment, the base station device receives the on/off decision information from a near-real-time controller (e.g., Near-RT RIC) through a control interface (e.g., E2 interface of O-RAN). In another embodiment, the base station device may receive the on/off decision information directly from a network control device (e.g., Non-RT RIC) through a management interface (e.g., O1 interface). In another embodiment, an E2 node may receive the on/off decision information directly from the Non-RT RIC through the O1 interface. In yet another embodiment, the on/off decision information is configured as binary values for each cell, where 1 indicates a cell on state and 0 indicates a cell off state. In an additional embodiment, the on/off decision information may include parameters such as on/off switching time, transition time, handover trigger conditions, and the like.

In step 920, the base station device hands over user terminals being served by cells determined to be off among the plurality of cells to cells determined to be on according to the on/off decision information. In one embodiment, the base station device identifies a list of all active user terminals connected to the cells determined to be off. In another embodiment, the base station device evaluates signal quality of adjacent cells for each user terminal to select an optimal target cell. In yet another embodiment, the base station device transmits handover commands to the user terminals and manages handover procedures. In an additional embodiment, the base station device may distributedly allocate user terminals to a plurality of on-state cells in consideration of load balancing.

In step 930, the base station device deactivates the cells determined to be off after completion of handover.

In a first embodiment, the base station device starts cell deactivation after confirming that handover of all user terminals has been successfully completed.

In a second embodiment, cell deactivation includes a process of stopping radio transmission/reception functions and switching baseband processing functions to minimum power mode.

In a third embodiment, the base station device periodically monitors the state of deactivated cells and maintains a standby mode for rapid reactivation when necessary.

In a fourth embodiment, the base station device may measure channel state information of the plurality of cells and periodically transmit the measured channel state information to the network control device. The measured CSI includes CQI, RSRP, SINR, and the like, and is utilized as input data for next on/off decisions.

In a fifth embodiment, when traffic load exceeds a threshold, the base station device may request reactivation of deactivated cells to the network control device. This is for maintaining service quality in response to sudden traffic increases.

In a sixth embodiment, in case of an emergency situation or disaster situation, the base station device may immediately activate all cells regardless of on/off decisions to ensure emergency communication services.

The methods according to embodiments described in the claims or specification of the present disclosure may be implemented in the form of hardware, software, or a combination of hardware and software.

When implemented as software, a computer-readable storage medium storing one or more programs (software modules) may be provided. The one or more programs stored in the computer-readable storage medium are configured for execution by one or more processors within an electronic device. The one or more programs include instructions that cause the electronic device to execute methods according to embodiments described in the claims or specification of the present disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs) or other forms of optical storage devices, or magnetic cassettes. Alternatively, they may be stored in memory configured as a combination of some or all of these. In addition, each configuration memory may be included in plural.

In addition, the program may be stored in an attachable storage device that can be accessed through a communication network such as the Internet, Intranet, local area network (LAN), wide area network (WAN), or storage area network (SAN), or a communication network configured as a combination thereof. Such storage devices may connect to a device performing embodiments of the present disclosure through an external port. In addition, a separate storage device on the communication network may also connect to a device performing embodiments of the present disclosure.

In the specific embodiments of the present disclosure described above, components included in the disclosure are expressed in singular or plural form according to the specific embodiments presented. However, the singular or plural expressions are selected to be appropriate for the situation presented for convenience of description, and the present disclosure is not limited to singular or plural components, and even components expressed in plural form may be configured in singular form, or components expressed in singular form may be configured in plural form.

Meanwhile, although specific embodiments have been described in the detailed description of the present disclosure, various modifications are possible without departing from the scope of the present disclosure. Therefore, the scope of the present disclosure should not be limited to the described embodiments and should be defined not only by the scope of the claims described below but also by those equivalent to the scope of the claims.

What is claimed is:

1. A method of operating a network control device for network energy saving in a wireless communication system, the method comprising:
collecting time-sequential channel state information from a plurality of cells;
generating on/off decision information for each of the plurality of cells based on the time-sequential channel state information using an artificial intelligence model; and
controlling on/off states of the plurality of cells by transmitting the on/off decision information to a base station device.

2. The method of claim 1, wherein the artificial intelligence model comprises:
a time-sequential learning layer that receives the time-sequential channel state information;
a fully connected layer that processes an output of the time-sequential learning layer; and
a threshold filter that generates the on/off decision information by applying a threshold to an output of the fully connected layer.

3. The method of claim 1, wherein collecting the time-sequential channel state information comprises:
storing channel state information during a preset time window; and
deleting channel state information exceeding the time window.

4. The method of claim 1, further comprising:
calculating network energy saving performance based on network performance metrics and energy consumption; and
training the artificial intelligence model to maximize the network energy saving performance.

5. The method of claim 4, wherein the network energy saving performance is calculated as a weighted difference between a total data rate of user terminals and a total power consumption of the plurality of cells.

6. A method of operating a base station device for network energy saving in a wireless communication system, the method comprising:
receiving on/off decision information for a plurality of cells from a network control device;
handing over user terminals being served by cells determined to be off among the plurality of cells to cells determined to be on according to the on/off decision information; and
deactivating the cells determined to be off after completion of the handover.

7. The method of claim 6, further comprising:
measuring channel state information of the plurality of cells; and
periodically transmitting the measured channel state information to the network control device.

8. The method of claim 6, wherein deactivating the cells determined to be off comprises:
stopping radio transmission/reception functions of the corresponding cells; and
switching baseband processing functions to minimum power mode.

9. The method of claim 6, further comprising requesting reactivation of the deactivated cells to the network control device when traffic load exceeds a threshold.

10. The method of claim 6, wherein the on/off decision information is configured as binary values for each cell.

11. A network control device for network energy saving in a wireless communication system, the device comprising:
a transceiver; and
a processor operatively connected to the transceiver,
wherein the processor is configured to:
collect time-sequential channel state information from a plurality of cells;
generate on/off decision information for each of the plurality of cells based on the time-sequential channel state information using an artificial intelligence model; and
control on/off states of the plurality of cells by transmitting the on/off decision information to a base station device.

12. The device of claim 11, wherein the artificial intelligence model comprises:
a time-sequential learning layer that receives the time-sequential channel state information;
a fully connected layer that processes an output of the time-sequential learning layer; and
a threshold filter that generates the on/off decision information by applying a threshold to an output of the fully connected layer.

13. The device of claim 11, wherein the processor is configured to store channel state information during a preset time window and delete channel state information exceeding the time window.

14. The device of claim 11, wherein the processor is configured to calculate network energy saving performance based on network performance metrics and energy consumption and train the artificial intelligence model to maximize the network energy saving performance.

15. The device of claim 14, wherein the network energy saving performance is calculated as a weighted difference between a total data rate of user terminals and a total power consumption of the plurality of cells.
